(19) United States
(12) Patent Application Publication
(10) Pub. No.: US 2011/0285863 A1
(43) Pub. Date: Nov. 24, 2011

(54) LIVE TELEVISION BROADCASTING SYSTEM FOR THE INTERNET

(76) Inventors: JAMES BURKE, SPOKANE, WA (US); DANIEL STUTZKE, MEAD, WA (US)

(21) Appl. No.: 13/113,983

(22) Filed: May 23, 2011

Related U.S. Application Data
(60) Provisional application No. 61/347,429, filed on May 23, 2010.

(51) Int. Cl. H04N 5/225

(52) U.S. Cl. 348/207.1; 348/E05.048

(57) ABSTRACT

Live television broadcasting systems for the Internet are provided. An example system provides a broadcasting-system-in-a-bag that self-connects camera and video stream to the Internet. The example system captures video at a high quality frame resolution (capturing audio too) and compresses the resulting multimedia steam to balance quality against bandwidth for bitrates that do not tax or overload an average broadband connection or CPU. The live video stream may be viewed immediately in a high quality resolution by web browsers, for example, on a dedicated channel, and made available on many devices and platforms, including computers, wireless phones, and other wireless handheld devices. A web service can provide access in one place to numerous live broadcasts from many different users.

### RELATED APPLICATIONS

This patent application claims the benefit of priority to U.S. Provisional Patent Application No. 61/347,429 to Burke et al., entitled “Live TV for Internet Broadcasting System,” filed May 23, 2010 and incorporated herein by reference in its entirety.

### BACKGROUND

Conventional live television for computers and devices that use the Internet has several obstacles. One problem has been providing a high enough quality video feed, without swamping the CPU processing power of the user's computing device and without overrunning the capacity or “bandwidth” of the user's Internet connection. It is easy to provide a low resolution video feed that does not use up all of the user's resources, but a live video feed at the quality of conventional television can put a severe strain on CPU usage and broadband Internet bandwidth.

Conventional videoconferencing has progressed toward the adoption of high definition (HD) screen resolution standards of 720 and 1080 HDTV. But such videoconferencing is not really intended for the “masses,” videoconferencing often relies on higher cost data connections with relatively high bandwidth, while most of the public just have average Internet connections with typical capacity. So a longstanding challenge has been to provide a high enough video resolution at bitrates that are feasible for most users.

Another problem with providing studio quality live video broadcast for the Internet, at least at the conventional resolution of typical TV tuner cards, has been initiation of the hardware and software involved. Determining the proper video camera settings to communicate with the local Internet source, configuring IP addresses, and formatting video for the intended end user, to name a few, have generally required either a technician at the site of video capture or significant time and effort on the part of an untrained enthusiast setting up by trial-and-error. Further, one-to-many broadcasting has conventionally involved custom application programming and/or custom web programming for each different type of device or platform to receive a live video feed, as shown in FIG. 1.

What is needed is a broadcast system amenable to quick and easy set-up at the site of live video capture that is able to send a high quality video feed that does not overload CPU and Internet bandwidth resources.

### SUMMARY

Live television broadcasting systems for the Internet are provided. An example system provides a broadcasting-system-in-a-bag that self-connects camera and video stream to the Internet. The example system captures video at a high quality frame resolution (capturing audio too) and compresses the resulting multimedia steam to balance quality against bandwidth for bitrates that do not tax or overload an average broadband connection or CPU. The live video stream may be viewed immediately in a high quality resolution by web browsers, for example, on a dedicated channel, and made available on many devices and platforms, including computers, wireless phones, and other wireless handheld devices. A web service can provide access in one place to numerous live broadcasts from many different users.

This summary section is not intended to give a full description of live television broadcasting systems for the Internet. A detailed description with example implementations follows.

### BRIEF DESCRIPTION OF THE DRAWINGS

FIG. 1 is a diagram of conventional obstacles for television over the Internet.

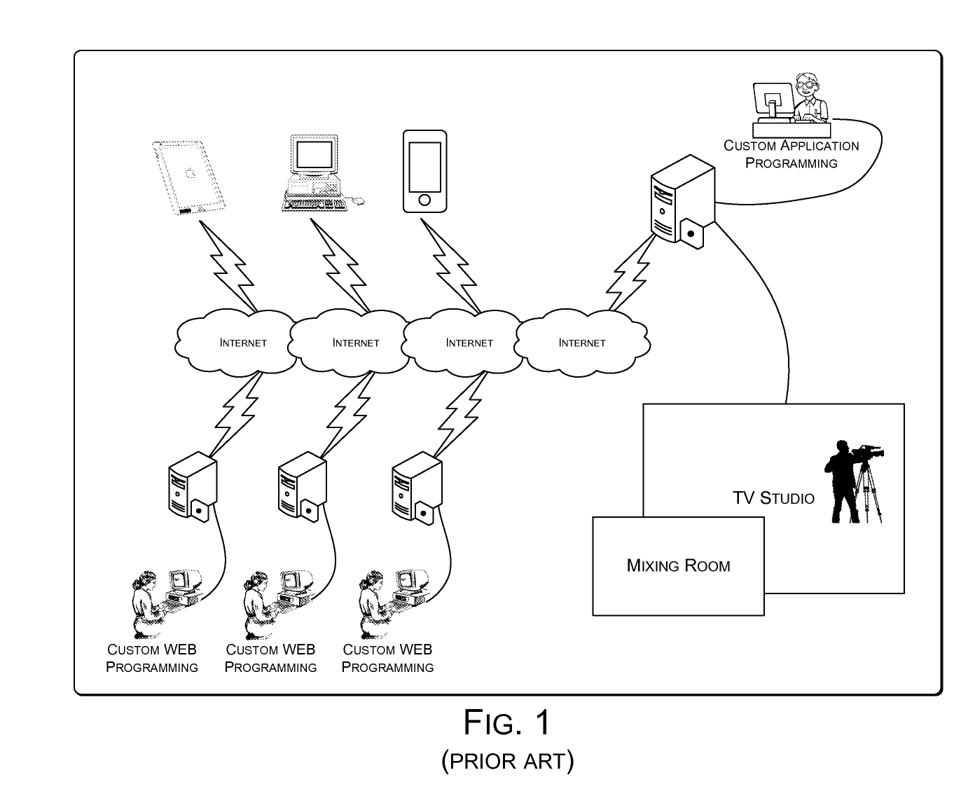

FIG. 2 is a diagram of an example live broadcast system.

FIG. 3 is a block diagram of an example connectivity engine 204.

FIG. 4 is a diagram of connectivity of the example system relative to the Internet.

FIG. 5 is a diagram of an example web service.

FIG. 6 is a diagram of an alternative example system using an analog video camera.

FIG. 7 is a flow diagram of an example method of live television broadcasting for the Internet.

### DETAILED DESCRIPTION

### Overview

This disclosure describes live television broadcasting systems for the Internet. An example system described herein provides a compact broadcasting-system-in-a-bag that when powered on, automatically self-connects camera and video stream to the Internet, e.g., though a user's standard wireless Internet router. The example system captures video (and optionally audio) at a high quality video definition and compresses the video steam to bitrates that do not tax or overload an average broadband connection or CPU. The live video stream may be viewed immediately by web browser, for example, through a service, and made available on many devices, such as computers, set-top boxes, IPODS, IPADS, IPHONES, BLACKBERRIES, PS3's, etc.

In one implementation, the nominal frame resolution of the TV capture is intentionally selected to be relatively low (e.g., 480×360 pixels) to enable the video stream from the TV capture to be lean and nimble over limited-bandwidth connections and devices. Frame rates may be scaled down to, for example, 10 frames per second (fps). In one implementation, despite the relatively low capture resolution and associated low post-compression bitrate, e.g., 256 kilobits per second (kbps), the overall quality of the live video stream is high, despite the lower bitrate utilized for data transfer. In an example system, the overall quality of the live video stream is more dependent on the dependability of the video bitrate/pixels available as opposed to frame resolution, per se, taken in isolation. Thus, many of the streaming and synchronization problems (and costs) experienced with high-bitrate, high-definition frame resolutions are avoided at a lower (but still high quality) resolution. In one implementation, the system delivers live VGA quality video (640×480 frame resolution)—the native resolution of many TV tuner cards—through a 256 kbps (kilobit per second) stream. The final video often has a better appearance, looks better, than relatively higher definitions because although there is a negligible loss of sharpness when using a lean resolution of capture, this is typically not noticeable, and a slightly lower resolution can compensate for motion artifacts and pauses caused by data delays and data drop-outs, which can reduce visual quality when higher resolutions are attempted without the support of matching bandwidth in the user's devices and broadband Internet connection. In one implementation of the example system, a 256 kbps video stream from a 480×360 capture is reconstituted to provide 640×480 (VGA) live video at the user's endpoint, without overrunning the user's CPU and without being hampered by bandwidth problems on a typical or average broadband Internet connection.

Thus, example systems using the example video scheme provide instant hassle-free and technician-free live video, for example, at VGA resolution, that provides dependably high quality live video, with an overall quality that is often higher than higher resolution video, when the higher resolution video comes with irritating problems typically caused by limited bandwidth.

In one implementation, the example system includes a wireless handheld device, including a web application, which also links to the user's local router and immediately provides the camera user with a camera controller and an on-the-spot instance of the camera's video stream, for immediate visual feedback. Besides giving live, on-the-spot feedback of the live video being captured, the wireless handheld device may also optionally control pan-tilt-zoom (PTZ) functions and other camera functions, when included in the system. The handheld device may be, for example, an IPOD, IPHONE, etc.

In one implementation, the system connects to a web service, which may provide the user and the newly initiated video set-up with an instant channel and/or webpage with a channel. The web service may provide the live video streams of many participants or subscribers for availability to the public, i.e., a YOUTUBE-like presentation of live video streams. Or, a given user may designate a private audience for a given live video stream or channel, using a code, which must be entered to view the user's live video(s).

### Example System

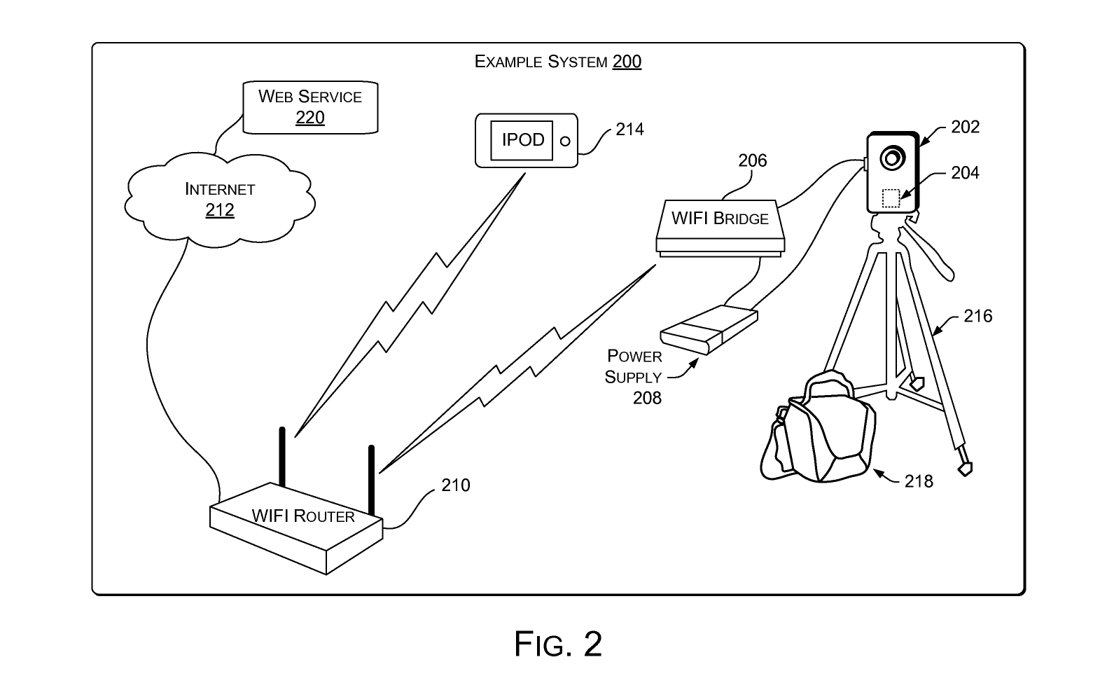

FIG. 2 shows an example live broadcast system 200. The system includes a video camera 202, such as an IP camera, an example connectivity engine 204 associated with the video camera 202, a wireless bridge 206, a power supply 208, such as a battery, a wireless router 210 coupled to the Internet 212, and a wireless handheld device 214, such as an IPOD or IPHONE. Other accessories for the example system include a camera tripod 216 and a tote bag 218 for the foregoing equipment. A web service 220 may also be associated with the example system 200, but is not part of the portable physical hardware assortment for use at the site of live video capture, shown in FIG. 2.

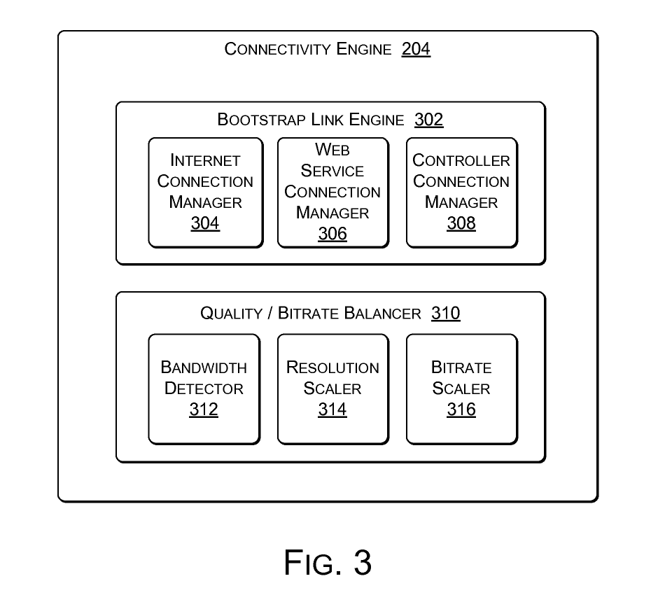

FIG. 3 shows the example connectivity engine 204 of FIG. 2, in greater detail. The illustrated implementation of the connectivity engine 204, or agent, is only one example configuration for the sake of description, to introduce features and components of an engine that can facilitate automatic or near-automatic set-up of the live video camera 202 and connections, and determine an appropriate bitrate for data transmission while maximizing video quality. The illustrated components are only examples. Different configurations or combinations of components than those shown may be used to practice live television broadcasting for the Internet. The example connectivity engine 204 can be implemented in hardware, or in combinations of hardware and software. Illustrated components are communicatively coupled with each other for communication as needed.

The connectivity engine 204 includes a bootstrap link engine 302, which may further include an Internet connection manager 304, a web service connection manager 306, and a controller connection manager 308. Straightforwardly, the Internet connection manager 304 tries to bootstrap a communicative connection with the Internet 212, that is, between the video camera 202 via the wireless bridge 206 and the wireless router 210, establishing all needed IP addresses and permissions. The web service connection manager 306 tries to bootstrap a communicative connection with the web service 220 to which the video camera 202 is programmed to connect, that is, between wireless bridge 206 and the web service 220, via the wireless router 210 and the Internet 212. The controller connection manager 308 tries to bootstrap a communicative connection between the wireless handheld device 214 and the video camera 202 and/or the web service 220, through the wireless router 210, the wireless bridge 206, the Internet 212, etc.

The example connectivity engine 204 may also include a quality/bitrate balancer 310, including a bandwidth detector 312, a resolution scaler 314, and a bitrate scaler 316. The bandwidth detector 312 may have access to default Internet bandwidth values, or the value may be user input. The bitrate scaler 316 may select a viable bitrate for the given Internet connection, and the resolution scaler 314 may adjust resolutions and/or frame rates accordingly. In some versions of the example system 200, the bitrates and resolutions may be hardwired or programmed into the example system 200.

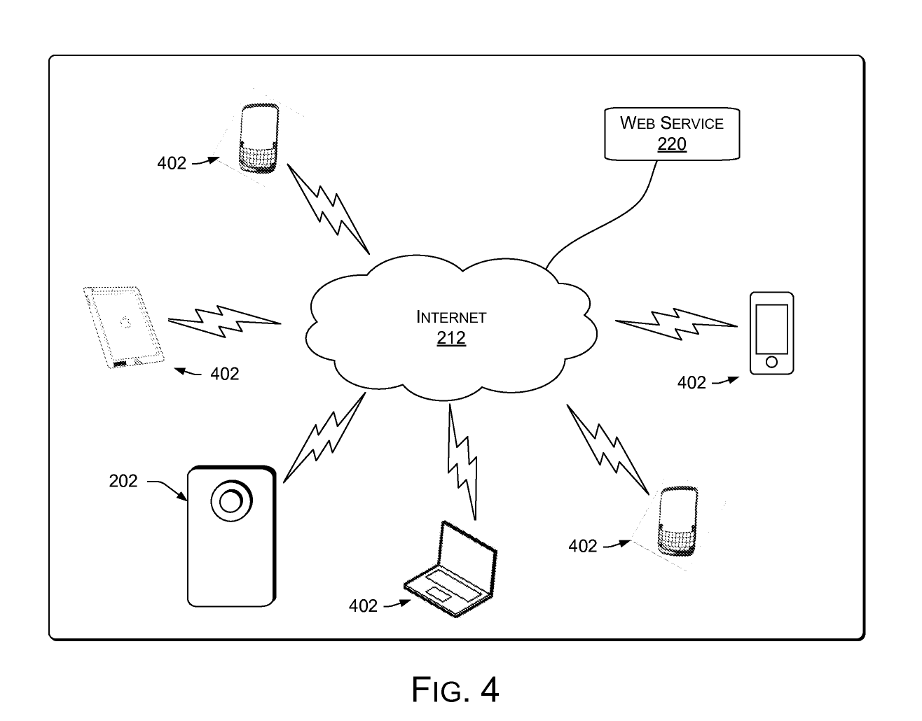

FIG. 4 shows Internet-centric connectivity of the different elements of an example system. The video camera 202 connects to the web service 220 via the Internet 212, and the web service 220 broadcasts the high quality video stream to numerous devices and platforms via the Internet 212.

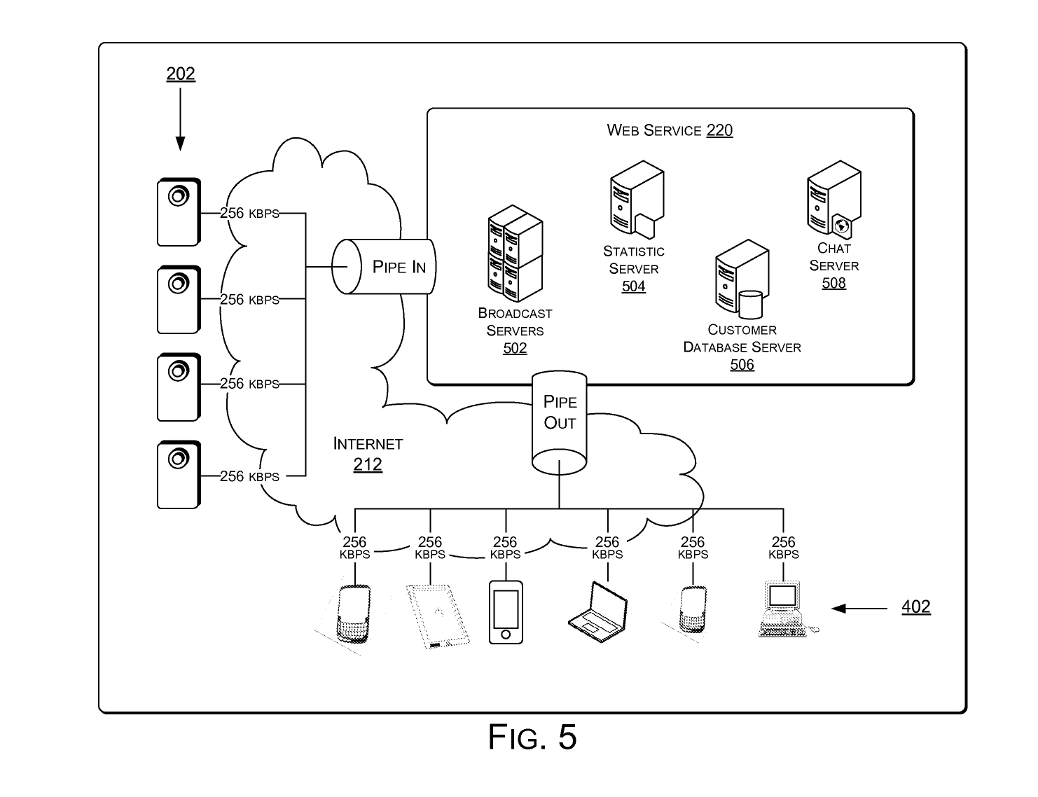

FIG. 5 shows an example web service 220. The example web service 220 receives numerous live video bitstreams from the individual video cameras 202 of numerous participants or subscribers. The web service 220 may include broadcast servers 502, statistic servers 504, customer database servers 506, chat servers 508, etc. The broadcast servers 502 transmit selected video bitstreams to end user devices 402. The signaling can include two-way communication, when an end user 402 wants to have an audio conversation at the site of the video camera 202 via speaker and microphones at the video capture site, over the same Internet connection as the live video is being streamed.

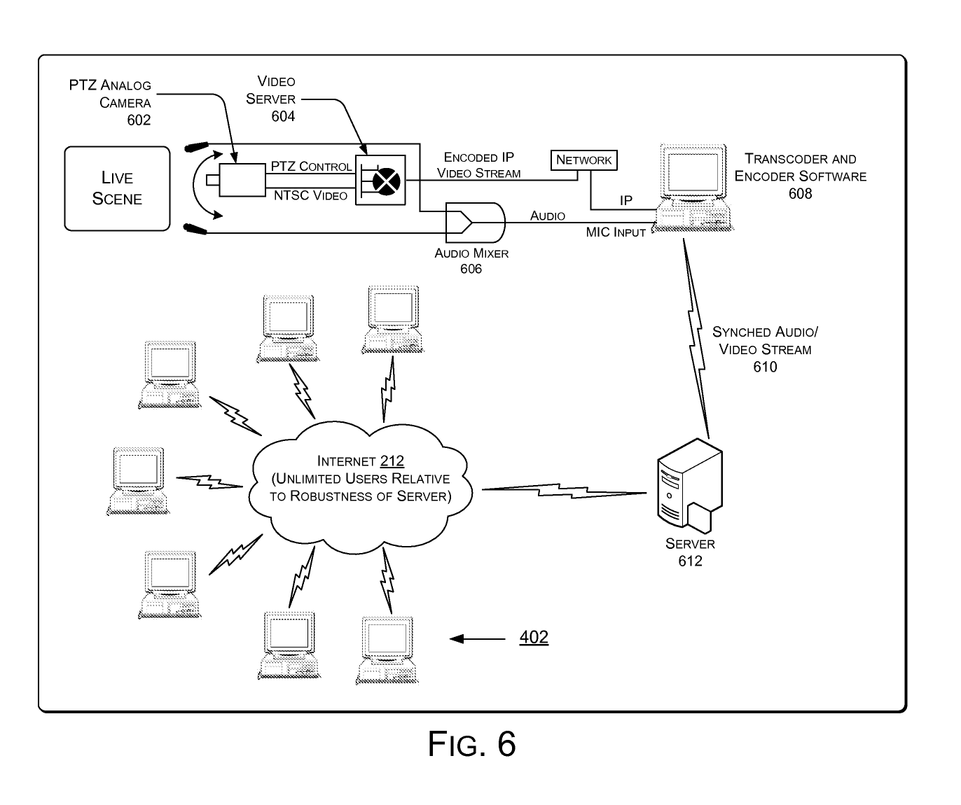

FIG. 6 shows an alternative implementation, in which an analog video camera 602, in this case also using stereo microphones, is used in the example system 200. An initial video server 604 may convert NTSC analog video, and optionally pan-tilt-zoom (PTZ) control signals, to an encoded IP data stream. An audio mixer 606 adds in the audio to a computing device running a transcoder/encoder application 608. A synchronized audio/video stream 610 is sent to a server 612 and hence to the Internet 212 for broadcast to end users 402.

### Operation of the Example System

In one implementation, the example system 200 uses an IP-based video camera 202, such as an AXIS M10 Series network camera, with integrated microphone or, with certain upgrades, with an external microphone as the video capture and transmitting device (Axis Communications, Lund, Sweden). The connectivity engine 204 or other components of the example system 200 integrate a “push” function as part of the operating system. In one implementation, the push function used by many video cameras 202 enables them to be adopted into the example system 200 to function in compatibility with the web service 220 as on-line video streamers. The web service connection manager 306 may contain the push function to enable automatic linkage between the video camera 202 and a re-broadcasting server somewhere on the Internet 212 whenever the camera is turned on. An H.264 codec stream, for example, automatically becomes accessible by any viewer throughout the world via a website of the web service 220 simply by activating the website on any computer, APPLE device, ANDROID device, PS3, or other device that is Internet-ready and can play streaming video.

Once a video camera 202 is initially programmed to be a part of the example system 200, any user of the device can create their own broadcast studio and provide real-time content via the web service 220 upon energizing the video camera unit 202.

The connectivity engine 204, and the example system 200 in general, allows each user at a video capture site to eliminate the need for camera techs, programmers, servers, etc., that currently must be employed to achieve a real-time broadcast to the viewing public. In the example system 200, the Internet 212 instantly becomes the transport mechanism eliminating the need for TV broadcast studios and video translating systems that conventionally must be used as the interim step to stream live video to the Internet 212. The web service 220 eliminates the need for web programming to display the live video stream that the camera user must employ in the current state of such broadcasting.

The example system 200 may employ a unique process that encodes a live scene using high quality video camera technology in a 480×360 ratio, compressing the signal into a small 256 Kbps stream, which has a negligible effect upon the bandwidth of the camera user's broadband service. The native resolution of many TV tuner cards is 640×480, that is, VGA quality. A 640×480 frame has 307,200 pixels, while a 480×360 frame only has 172,800 pixels, a reduction of almost 50%. By reducing the number of actual pixels in a given frame in this matter, the quality/bitrate balancer 310 of the connectivity engine 204 can increase the bitrate per pixel, thus allowing the codec more room to compensate for high motion in a given scene. This actually increases quality, despite a lower frame resolution, when the broadband Internet bandwidth is just average and cannot support higher bitrates without overrunning the capacity.

A single bitstream from each video camera 202 is sent to a re-broadcasting server on the Internet 212 where large bandwidth is available, placing the entire bandwidth load upon the re-broadcasting server, not the video camera 202. The web service 220 can also enhance or expand the 256 kbps bitstream out to a 640×480 screen resolution (VGA) at the end user's device 402. Thus, in one implementation an example display system employs a 640×480 ratio thus expanding the original 480×360 high quality video to a larger viewing area without impacting the actual bitrate of the video stream. This quality versus bitrate balancing serves at least three useful purposes. First, it provides a high quality image while using minimal bandwidth. Second, it provides a clear, high frame-rate, fluid streaming effect for the viewer. And finally, it does not severely impact the display device's CPU usage.

The example system 200 thus provides real-time video streaming of high quality at a fraction of the cost of conventional television quality broadcast on the Internet 212 without unduly impacting the video camera user, or the end user viewing one of the broadcasts.

For set-up, in one implementation, the content provider (e.g., customer that purchases the example system 200) enables broadcasting by simply plugging in the included wireless router 210 into any available Ethernet connection, and connects the “studio-in-a-bag” to the video camera 202 and powers up the system.

Upon boot-up, the connectivity engine 204 pushes a single H.264 video/audio stream via RTSP transport protocol to a broadcast server 502 associated with the web service 220. This push function eliminates the need for the content provider to understand IP setup protocols. The broadcast server 502 then re-broadcasts the single, incoming H.264 stream to any viewer watching via a website of the web service 220, e.g., Internet channel, anywhere in the world. The end user 402 may use numerous types of devices and platforms. The broadcast server 502 may employ a WOWZA server application. WOWZA enables a server to stream live and on-demand video, audio, and RIAs (Rich Internet Applications) over public and private IP networks to desktop/laptop/tablet computers, mobile devices, IPTV set-top boxes, Internet-connected TV sets, and other network-connected devices. The server may be a JAVA application deployable on the following operating systems: WINDOWS, LINUX, MAC OS X, SOLARIS, and UNIX. WOWZA Media Server can stream to multiple types of playback clients and devices simultaneously, including the ADOBE Flash player, MICROSOFT SILVERLIGHT player, APPLE QuickTime player, and IOS devices (IPhone/IPad/IPod-touch), 3GPP mobile phones (BLACKBERRY, ANDROID, SYMBIAN, etc), IPTV set-top boxes: AMINO, ENSEO, ROKU, and others), and game consoles such as WII and PS3 (Wowza Media Systems, Evergreen, Colo.).

In one implementation, a user interface may provide a viewing panel/pane that is presented to end user viewers 402 as part of a user interface at a size that may be much larger than customary for some online streaming video applications. For example, the area of the viewing panel may be four times larger than current delivery mechanisms for like video. The user interface may be provided as a web page or as another Internet browser-readable program.

Through the user interface, the example system 200 may provide communications between viewers 402 and/or between one or more moderators, which may include a system user, operator, or broadcasting entity that is associated with the video camera 202 or delivery of the streaming content. In one implementation, communication to the moderator(s) and/or between viewers may be in the form of an integrated chat function. The chat function may be provided as a chat window associated with the viewing window. Thus, according to one implementation, one or more viewers may view the viewing panel and may interact with the user interface via a chat window through the same user interface. The chat window may additionally or alternatively allow viewers to see one or more other viewers or moderators associated with the chat and/or comments made by other users in the chat window. This provides a community feel to the broadcast.

An integrated remote control icon array may be displayed within the user interface to allow one or more of the viewers to enter into the full-duplex communications feature for controlling PTZ video camera movement as well as providing channel-changing capabilities to view signals from other cameras, other computing devices and/or other Internet servers.

In one implementation, the example system 200 may provide for recording of broadcasts. The example system 200 may provide for full archiving of any broadcast providing “reruns” of any broadcast, which may have originally been presented to viewers “live.” Viewers may be able to access to these reruns and/or other content using via the control interface displayed within the user interface.

Instant snap-shots of any video content may also be provided with the system. As one or more broadcasts are streaming the consumer may “snap” virtual photographs of the images displayed on the visual panel and/or other portion of the user interface. The images may then be stored on the viewer's computer or other storage medium for later viewing.

### Example Methods

In one example method, a subscription or participation is offered for a web service that publicly or privately broadcasts live video streams from multiple subscribers or participants. A video camera kit is provided to the subscribers or the participants, including: an Internet Protocol (IP) video camera or an analog video camera, a wireless bridge, a logic module included in a component of the kit for automatically bootstrapping a communicative link between the video camera and the web service via the Internet, and an encoder associated with the video camera for compressing a high quality video stream from the video camera to a bitrate suitable for an average broadband Internet connection.

A wireless controller may also be provided to the subscriber or participant to automatically link to the video camera and/or web service. The controller displays an instance of the bitstream of live video content and enables user control of the video camera and system settings.

A new channel for broadcasting a live video may be automatically initiated for a new subscriber or a new participant when the web service detects a new communicative link associated with the new subscriber or participant.

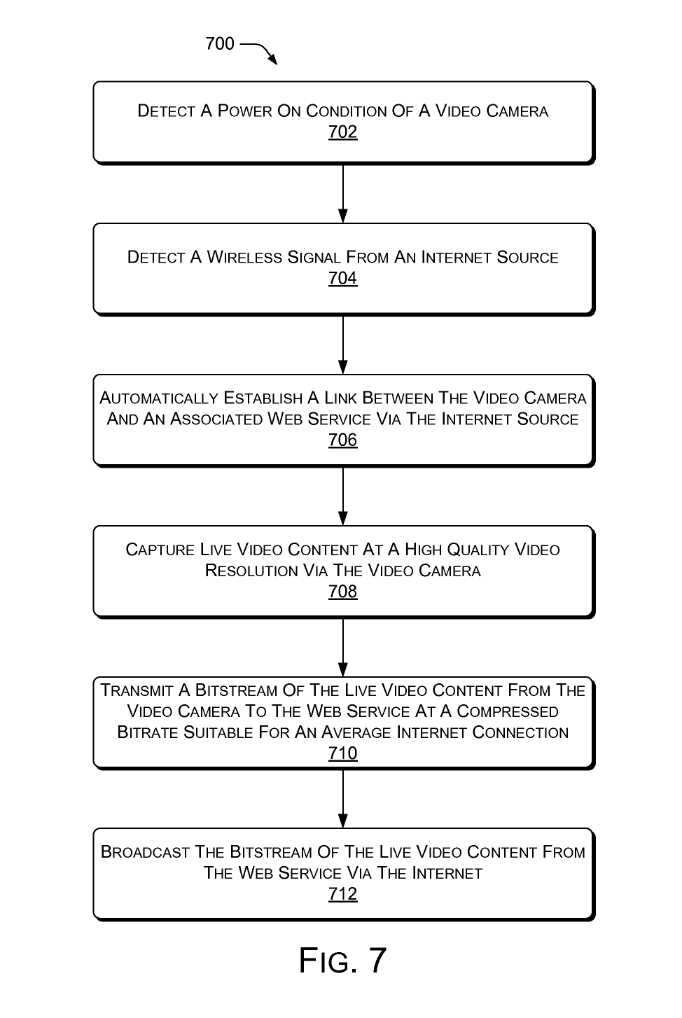

FIG. 7 is another example method 700 of live television broadcasting for the Internet. In the flow diagram, the operations are summarized in individual blocks. The example method 700 may be performed by hardware or combinations of hardware and software, for example, by the example system 200 and/or the example connectivity engine 204.

At block 702, a power-on condition of a video camera is detected by a bootstrapping agent.

At block 704, a wireless signal from an Internet source is detected by the bootstrapping agent.

At block 706, a link is automatically established between the video camera and an associated web service via the Internet source.

At block 708, live video content is captured at a high quality video resolution via the video camera.

At block 710, a bitstream of the live video content is transmitted from the video camera to the web service at a compressed bitrate suitable for an average broadband Internet connection.

At block 712, the bitstream of the live video content is broadcast from the web service via the Internet.

### Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A system, comprising:
a video camera;
a wireless bridge;
a connectivity engine;
a first logic module in the connectivity engine to automatically bootstrap an Internet connection between the video camera and a web service via the wireless bridge;
a second logic module in the connectivity engine to determine a bandwidth of the Internet connection and to establish a bitrate suitable for transmitting a high quality video stream without taxing the bandwidth;
an encoder to compress live video content from the video camera into a bitstream of live video content at the bitrate; and
a transmitter to stream the bitstream of live video content from the video camera to the web service at the bitrate.

2. The system of claim 1, further comprising a web service to receive the bitstream of live video content from the video camera and to broadcast the bitstream of live video content via the Internet.

3. The system of claim 1, wherein the logic module detects when the camera has been powered on, detects a wireless device through the wireless bridge, and automatically initiates a connection with the web service via the wireless device.

4. The system of claim 1, wherein the encoder compresses live data from the video camera into a bitstream of the live video content at approximately 256 kilobits per second.

5. The system of claim 1, wherein the video camera captures live video content at a frame resolution of approximately 480×360 pixels at a frame rate of approximately 10-30 frames per second; and
wherein the encoder compresses the live video content into a bitstream at approximately between 256-900 kilobits per second.

6. The system of claim 5, wherein the web service streams the bitstream of live video content from the web service to an Internet client to be displayed at the Internet client at a frame resolution of 680×480 pixels.

7. The system of claim 1, further comprising:
a wireless handheld controller;
an application associated with the wireless handheld controller;
wherein the wireless handheld controller detects a wireless device and establishes communication between the wireless handheld controller and the wireless device; and
wherein the application bootstraps a communicative coupling between the handheld wireless controller and the video camera through the wireless bridge.

8. The system of claim 7, wherein the application bootstraps a communicative coupling between the wireless handheld controller, the video camera, and the web service.

9. The system of claim 7, wherein the application displays an instance of the bitstream of live video content from the video camera on the wireless handheld controller.

10. The system of claim 7, wherein the application enables one of:
a selection of a user preference for the video camera; or
a control signal for the video camera.

11. The system of claim 2, wherein the web service provides broadcast of multiple live video streams from one or more web service participants.

12. The system of claim 2, wherein the web service automatically initiates a new channel when the web service detects a new connection to a video camera.

13. The system of claim 2, wherein the web service receives a bitstream of live content associated with a given frame resolution, and enhances the frame resolution for broadcast via the Internet.

14. The system of claim 1, wherein the video camera is one of an Internet Protocol (IP) camera or an analog camera.

15. A method, comprising:
detecting a power-on condition of a video camera;
detecting a wireless signal from an Internet source;
establishing a link between the video camera and an associated web service via the Internet source;
capturing live video content at a high quality video resolution via the video camera;
transmitting a bitstream of the live video content from the video camera to the web service at a compressed bitrate suitable for an average broadband Internet connection; and
broadcasting the bitstream of the live video content from the web service via the Internet.

16. The method of claim 15, further comprising enhancing the bitstream at the web service for the broadcasting.

17. The method of claim 15, further comprising automatically linking a wireless handheld controller to the video camera and/or to the web service to display an instance of the bitstream of live video content for user feedback and for sending a control signal and/or a user preference to the video camera.

18. A method comprising:
offering a subscription to, or a participation in, a web service for publicly or privately broadcasting live video streams from multiple subscribers or participants;
providing a video camera kit to the subscribers or the participants, including:
an Internet Protocol (IP) video camera or an analog video camera;
a wireless bridge;
a logic module for automatically bootstrapping a communicative link between the video camera and the web service via the Internet;
an encoder associated with the video camera for compressing a high quality video stream from the video camera to a bitrate suitable for an average broadband Internet connection.

19. The method of claim 18, further comprising providing a wireless controller to the subscriber or participant, wherein the wireless controller automatically links to the video camera and/or web service and displays an instance of the bitstream of live video content and enables user control of the video camera.

20. The method of claim 18, further comprising automatically initiating a new channel for broadcasting a live video from a new subscriber or a new participant when the web service detects a new communicative link associated with the new subscriber or the new participant.
